(19) United States
(12) Patent Application Publication
(10) Pub. No.: US 2024/0276181 A1
(43) Pub. Date: Aug. 15, 2024

(54) MULTICAST SERVICES IN CELLULAR COMMUNICATION NETWORKS

(71) Applicant: Nokia Technologies Oy, Espoo (FI)

(72) Inventors: Ugur Baran ELMALI, Munich (DE); Esa Mikael MALKAMÄKI, Espoo (FI); Bighnaraj PANIGRAHI, Bangalore (IN); Philippe GODIN, Massy (FR); Chitradeep MAJUMDAR, Bangalore (IN)

(21) Appl. No.: 18/416,555

(22) Filed: Jan. 18, 2024

(30) Foreign Application Priority Data
Feb. 10, 2023 (IN) 202341008738

(51) Int. Cl. H04W 4/06; H04W 76/40

(52) U.S. Cl. CPC H04W 4/06; H04W 76/40; H04L 12/189

(57) ABSTRACT

According to an example aspect of the present invention, there is provided a method, comprising determining by an apparatus, while the apparatus is in an inactive state and receiving a multicast service from a cell of a first wireless network node, that there is no delivery for the multicast service for user equipments in the inactive state in a cell of a second wireless network node, wherein the cell of the second wireless network node is a target cell intended by the apparatus for camping, transmitting to the first wireless network node by the apparatus, based on said determination, a request for reconnection to the cell of the first wireless network node and transmitting by the apparatus, to the first wireless network node, an indication indicating that the request is for reconnecting for service continuity of the multicast service.

### RELATED APPLICATION

This application claims priority to IN provisional Application No. 202341008738 filed Feb. 10, 2023, which is incorporated herein by reference in its entirety.

### FIELD

Various example embodiments relate in general to cellular communication networks and more specifically, to multicast services in such networks.

### BACKGROUND

Multicast services may be enabled in various cellular communication networks, such as in cellular communication networks operating according to 5G radio access technology, to send the same data to a plurality of receivers, but possibly not all. 5G radio access technology may also be referred to as new radio, NR, access technology. 3rd generation partnership project, 3GPP, develops standards for 5G/NR and some topics in the 3GPP discussions are related to multicast services. According to the discussions there is a need to provide improved methods, apparatuses and computer programs related to multicast services. Such improvements may be exploited in other cellular communication networks as well, like in 6G networks.

### SUMMARY

According to some aspects, there is provided the subject-matter of the independent claims. Some example embodiments are defined in the dependent claims.

The scope of protection sought for various example embodiments of the invention is set out by the independent claims. The example embodiments and features, if any, described in this specification that do not fall under the scope of the independent claims are to be interpreted as examples useful for understanding various example embodiments of the invention.

According to a first aspect of the present invention, there is provided an apparatus comprising at least one processor and at least one memory storing instructions that, when executed by the at least one processor, cause the apparatus at least to determine, while the apparatus is in an inactive state and receiving a multicast service from a cell of a first wireless network node, that there is no delivery for the multicast service for user equipments in the inactive state in a cell of a second wireless network node, wherein the cell of the second wireless network node is a target cell intended by the apparatus for camping, transmit to the first wireless network node, based on said determination, a request for reconnection to the cell of the first wireless network node and transmit, to the first wireless network node, an indication indicating that the request is for reconnecting for service continuity of the multicast service. The apparatus of the first aspect may be a user equipment, or a control device configured to control the functioning thereof, possibly when installed therein.

Example embodiments of the first aspect may comprise at least one feature from the following bulleted list or any combination of the following features:
wherein the at least one memory further stores instructions that, when executed by the at least one processor, cause the apparatus at least to receive, from the first wireless network node, a threshold value and transmit, to the first wireless network node, the request for the reconnection to the cell of the first wireless network node when measurement results of the cell of the first wireless network node are less than measurement results of the cell of the second wireless network node by at least the threshold value or when the measurement results of the cell of the second wireless network node are larger than the at least one threshold or when the measurement results of the cell of the first wireless network node are smaller than the at least one threshold;
wherein the at least one memory further stores instructions that, when executed by the at least one processor, cause the apparatus at least to receive, from the first wireless network node, at least one criterion and transmit, to the first wireless network node, the request for the reconnection with the cell of the first wireless network node when at least one of the at least one criterion is met;
wherein the at least one memory further stores instructions that, when executed by the at least one processor, cause the apparatus at least to receive, from the first wireless network node, information indicating that a reconnection to a cell of the first wireless network node is enabled for service continuity of the multicast service;
wherein said indication indicating that the request is for service continuity of the multicast service is transmitted in a radio resource control resume request message or in a radio resource control resume complete message;
wherein the at least one memory further stores instructions that, when executed by the at least one processor, cause the apparatus at least to transmit, to the first wireless network node, an indication indicating an expectation to receive a measurement request from the first wireless network node;
wherein said indication indicating said expectation to receive the measurement request from the first wireless network node is transmitted in a radio resource control resume request message;
wherein the at least one memory further stores instructions that, when executed by the at least one processor, cause the apparatus at least to receive, from the first wireless network node, a radio resource control resume message and transmit to the first wireless network node, responsive to receiving the radio resource control resume message, in a radio resource control resume complete message at least one of an identity of the cell of the second wireless network node, measurement results or a cause value indicating reconnecting for service continuity of the multicast service;
wherein said information indicating that the reconnection to the cell of the first wireless network node is enabled for service continuity of the multicast service is received on a multicast control channel.

According to a second aspect of the present invention, there is provided an apparatus comprising at least one processor and at least one memory storing instructions that, when executed by the at least one processor, cause the apparatus at least to receive, from a user equipment, a request for reconnection to a cell of the apparatus, receive, from the user equipment, an indication indicating that the request is for reconnecting for service continuity of a multicast service and transmit, based on the request and the indication, a request for measurements to the user equipment or a handover request to a second wireless network node. The apparatus of the second aspect may be a wireless network node, or a control device configured to control the functioning thereof, possibly when installed therein.

Example embodiments of the second aspect may comprise at least one feature from the following bulleted list or any combination of the following features:
wherein the at least one memory further stores instructions that, when executed by the at least one processor, cause the apparatus at least to transmit, to the user equipment, at least one criterion, receive, from the user equipment, the request for the reconnection to the cell of the apparatus when at least one of the at least one criterion is met;
wherein the at least one memory further stores instructions that, when executed by the at least one processor, cause the apparatus at least to decide to enable the reconnection to the cell of the apparatus for service continuity of the multicast service with the user equipment in the inactive state and transmit, to the user equipment, information indicating that the reconnection to the cell of the apparatus is enabled for service continuity of the multicast service;
wherein said indication indicating that the request is for reconnecting for service continuity of the multicast service is received in a radio resource control resume request message or in a radio resource control resume complete message;
wherein the at least one memory further stores instructions that, when executed by the at least one processor, cause the apparatus at least to receive, from the user equipment, an indication indicating an expectation to receive a measurement request from the apparatus is to request measurements and transmit, to the user equipment, a request for said measurements.
wherein said indication indicating said expectation to receive the measurement request from the first wireless network node is received in a radio resource control resume request message;
wherein the at least one memory further stores instructions that, when executed by the at least one processor, cause the apparatus at least to transmit, to the user equipment, a radio resource control resume message and receive from the user equipment, responsive to transmitting the radio resource control resume message, in a radio resource control resume complete message at least one of an identity of a cell of a second wireless network node, measurement results or a cause value indicating reconnection for service continuity;
wherein the at least one memory further stores instructions that, when executed by the at least one processor, cause the apparatus at least to decide, based on the radio resource control resume complete message received from the user equipment, to handover the user equipment to the cell of the second wireless network node;
wherein said information indicating that the reconnection to the cell of the first wireless network node is enabled for service continuity of the multicast service is transmitted on a multicast control channel.

According to a third aspect of the present invention, there is provided a first method, comprising determining by an apparatus, while the apparatus is in an inactive state and receiving a multicast service from a cell of a first wireless network node, that there is no delivery for the multicast service for user equipments in the inactive state in a cell of a second wireless network node, wherein the cell of the second wireless network node is a target cell intended by the apparatus for camping, transmitting to the first wireless network node by the apparatus, based on said determination, a request for reconnection to the cell of the first wireless network node and transmitting by the apparatus, to the first wireless network node, an indication indicating that the request is for reconnecting for service continuity of the multicast service. The first method may be performed by a user equipment, or a control device configured to control the functioning thereof, possibly when installed therein.

According to a fourth aspect of the present invention, there is provided a second method, comprising receiving by apparatus, from a user equipment, a request for reconnection to a cell of the apparatus, receiving by the apparatus, from the user equipment, an indication indicating that the request is for reconnecting for service continuity of a multicast service and transmitting by the apparatus, based on the request and the indication, a request for measurements to the user equipment or a handover request to the second wireless network node. The second method may be performed by a wireless network node, or a control device configured to control the functioning thereof, possibly when installed therein.

According to a fifth aspect of the present invention, there is provided an apparatus, comprising means for determining, while the apparatus is in an inactive state and receiving a multicast service from a cell of a first wireless network node, that there is no delivery for the multicast service for user equipments in the inactive state in a cell of a second wireless network node, wherein the cell of the second wireless network node is a target cell intended by the apparatus for camping, means for transmitting to the first wireless network node by the apparatus, based on said determination, a request for reconnection to the cell of the first wireless network node and means for transmitting by the apparatus, to the first wireless network node, an indication indicating that the request is for reconnecting for service continuity of the multicast service. The apparatus of the fifth aspect may be a user equipment, or a control device configured to control the functioning thereof, possibly when installed therein.

According to a sixth aspect of the present invention, there is provided an apparatus, comprising means for determining, while the apparatus is in an inactive state and receiving a multicast service from a cell of a first wireless network node, that there is no delivery for the multicast service for user equipments in the inactive state in a cell of a second wireless network node, wherein the cell of the second wireless network node is a target cell intended by the apparatus for camping, means for transmitting to the first wireless network node, based on said determination, a request for reconnection to the cell of the first wireless network node and means for transmitting, to the first wireless network node, an indication indicating that the request is for reconnecting for service continuity of the multicast service. The apparatus of the sixth aspect may be a wireless network node, or a control device configured to control the functioning thereof, possibly when installed therein.

According to a seventh aspect of the present invention, there is provided a non-transitory computer readable medium having stored thereon a set of computer readable instructions that, when executed by at least one processor, cause an apparatus to at least perform the first or the second method. According to an eighth aspect of the present invention, there is provided a computer program comprising instructions which, when the program is executed by an apparatus, cause the apparatus to carry out the first or the second method.

### BRIEF DESCRIPTION OF THE DRAWINGS

FIG. 1 illustrates an example of a network scenario in accordance with at least some example embodiments;

FIG. 2 illustrates a signalling graph in accordance with at least some example embodiments;

FIG. 3 illustrates an example apparatus capable of supporting at least some example embodiments;

FIG. 4 illustrates a flow graph of a first method in accordance with at least some example embodiments.

### EXAMPLE EMBODIMENTS

Embodiments of the present disclosure provide improvements for delivery of multicast services in cellular communication networks. More specifically, embodiments of the present disclosure enable continuity of multicast services in cases, wherein a cell of a wireless network node, which a User Equipment, UE, in an inactive state has selected as a target cell for a handover, does not deliver a multicast service for UEs in the inactive state. The UE may be allowed to reconnect to its serving cell in such cases, thereby enabling network control for such reconnections and service continuity. Thus, delivery of multicast services may be improved.

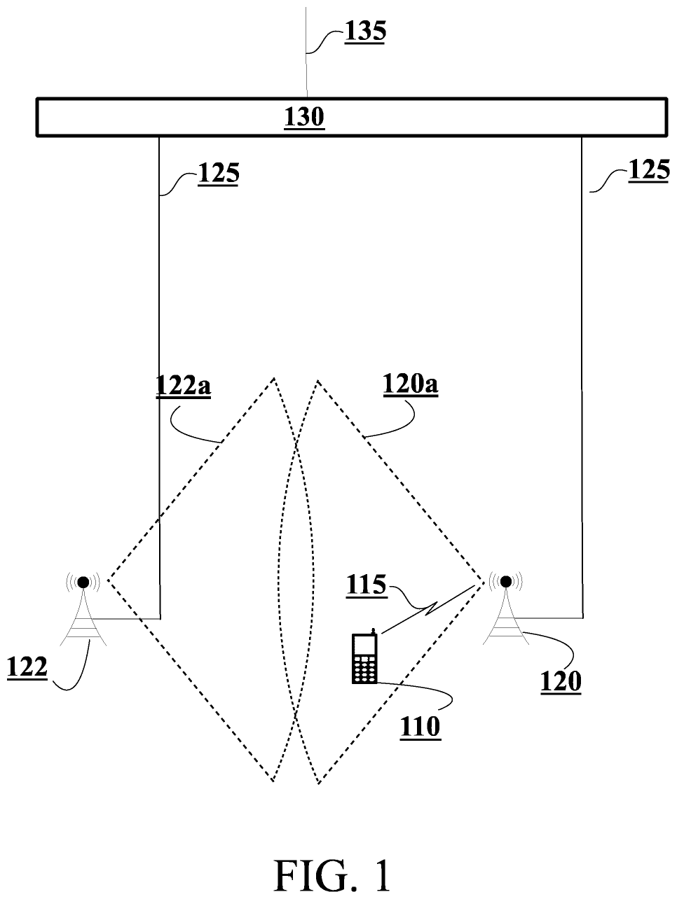

FIG. 1 illustrates an example of a network scenario in accordance with at least some example embodiments. According to the example scenario of FIG. 1, there may be a network scenario comprising UE 110, first wireless network node 120, second wireless network node 122 and core network 130. First wireless network node 120 may be configured to control cell 120a and second wireless network node 122 may be configured to control cell 122a. First wireless network node 120 may be a serving network node for UE 110 and cell 120a of first wireless network node 122 may be a serving cell for UE 110. UE 110 and first wireless network node 120 may be connected to each other via air interface 115.

UE 110 may comprise, for example, a smartphone, a cellular phone, a Machine-to-Machine, M2M, node, Machine-Type Communications, MTC, node, an Internet of Things, IoT, node, a Reduced Capability, RedCap, node, a car telemetry unit, a laptop computer, a tablet computer or, indeed, any kind of suitable wireless terminal.

Air interface 115 between UE 110 and first wireless network node 120 may be configured in accordance with a first RAT which UE 110 and first wireless network node 120 are configured to support. Examples of cellular RATs include Long Term Evolution, LTE, New Radio, NR, which may also be known as fifth generation, 5G, radio access technology, 6G, and MulteFire. A cellular RAT may be standardized by a 3rd Generation Partnership Project, 3GPP, for example. Hence, UE 110, and wireless network nodes 120 and 122 as well, may be configured to operate according to at least one 3GPP standard.

For example in the context of LTE, wireless network nodes 120 and 122 may be referred to as eNBs while wireless network nodes 120 and 122 may be referred to as gNBs in the context of NR. In some example embodiments, wireless network nodes 120 and 122 may be referred to as Transmission and Reception Point, TRPs, or control multiple TRPs that may be co-located or non-co-located. In any case, example embodiments of the present disclosure are not restricted to any particular wireless technology. Instead, example embodiments may be exploited in any wireless communication system, wherein multicast services are provided.

Wireless network nodes 120 and 122 may be connected, directly or via at least one intermediate node, with core network 130 via wired interface 125. Core network 130 may be, in turn, coupled via interface 135 with another network (not shown in FIG. 1), via which connectivity to further networks may be obtained, for example via a worldwide interconnection network. In some example embodiments, first wireless network node 120 may be connected with second wireless network node 122 via an inter-base station interface (not shown in FIG. 1), even though in some embodiments the inter-base station interface may be absent. Wireless network nodes 120 and 122 may be connected, directly or via at least one intermediate node, with core network 130 or with another core network.

If UE 110 is in an inactive state, like Radio Resource Control, RRC, RRC_INACTIVE state, UE 110 may apply a configuration of a multicast service in cell 120a of first wireless network node 120 to start and continue receiving the multicast service to which UE 110 has joined. Moreover, UE 110 in the inactive state should be able to move to another cell in an RAN-based Notification Area, RNA, like cell 122a of second wireless network node 122, while receiving the multicast service without notifying the network. In addition, UE 110 should be able to receive the multicast service also in said another, new cell selected after a cell reselection process made by UE 110, like cell 122a of second wireless network node 122, if the multicast service is provided to UEs in the inactive state in the new cell. In some example embodiments, UE 110 may perform cell reselection and the new cell may be referred to as a target cell, intended by UE 110 for camping. Hereby, the intention of the UE to camp on the target cell comprises the UE determining that the said target cell is considered by the UE as a suitable future cell to camp on.

For instance, to be able to receive the multicast service in the new cell, UE 110 may first read a System Information Block, SIB, like SIB20. The SIB may be a SIB of the new cell, i.e., a neighbour cell that provides a configuration for a Multicast Control Channel, MCCH. UE 110 may then wait for the periodic MCCH to be scheduled and learn how to receive the multicast service in question. Reception of the multicast service may refer to receiving multiple multicast transmissions.

Enabling multicast reception for UEs in the inactive state may be a per cell decision. Therefore, in some example embodiments, UE 110 may determine that there is no delivery for the multicast service in the new cell for UEs in the inactive state, possibly based on information received on the MCCH. In such a case, UE 110 may need to perform reconnection to the new cell and move to a connected state, like RRC_CONNECTED state, in the new cell. Alternatively, the multicast service may not be provided in the new cell at all, e.g., if there are no UEs in the new cell that have joined the multicast service (Multicast and Broadcast Service, MBS, session not established yet) or if the size of the audience receiving the multicast service in the connected state is small. Hence, there could be some delays which should be avoided.

If UE 110 determines that there is no delivery for the multicast service that it has joined for UEs in the inactive state in the new cell, UE 110 may reconnect to its serving cell, like cell 120a of first wireless network node 120 in the example of FIG. 1. After reconnecting to its serving cell, UE 110 may start receiving data from its serving cell in the connected state and be later on handed over to the new cell while keeping the service continuity via handover procedures.

However, such a procedure may cause various issues. For instance, in case of congestion scenarios first wireless network node 120 of cell 120a may decide to enable reception of the multicast service for UEs in the inactive state. That is, first wireless network node 120 of cell 120a may decide not to serve all UEs in the connected state. Therefore, it might not be desirable to move such UEs into the connected state all the time in cell 120a just to ensure lossless mobility for one UE 110 if UE 110 is potentially to be handed over. One challenge thus is how to avoid reconnecting to cell 120a all the time.

Another issue may be that when going into the connected state in cell 120a, control of cell selection (i.e., handover) may be given to first wireless network node 120. Handover decisions may be done for example based on measurement reports. Based on the measurement reports, first wireless network node 120 might decide not to hand UE 110 over to a neighbor cell, like cell 120a, for a long period of time. Alternatively, UE 110 may change its direction and stay in cell 120a. The challenge thus is how to align such decisions of UE 110 and wireless network node 120.

Example embodiments of the present disclosure therefore make it possible for first wireless network node 120 to control reconnections in cell 120a, i.e., in the serving cell of UE 110, with the aim to provide continuity of the multicast service for UE 110. Also, first wireless network node 120 may align decisions of cell selection in UE 110 and handover in first wireless network node 120, while still being able to provide service continuity for the multicast service.

In some example embodiments, first wireless network node 120 may transmit information to UE 110, said information indicating that a reconnection with cell 120a of first wireless network node 120 is enabled for continuing the multicast service. That is, said information may be about enabling such operation for UEs in the inactive state, like UE 110. Said information may be transmitted on the MCCH or in a SIB. That is, first wireless network node 120 may signal in a SIB or the MCCH about enabling or disabling of such UE operation of reconnecting for service continuity per Group Radio Network Temporary Identifier, G-RNTI, or per cell. Therefore, first wireless network node 120 may decide to enable a reconnection for continuing the multicast service, e.g., in case the congestion at first wireless network node 120 is not severe. In some example embodiments, wireless network node 120 may decide to disable the reconnection for continuing the multicast service, for example if the congestion becomes severe later on. In such a case, UE 110 should not try to reconnect to cell 120a of first wireless network node 120.

In some example embodiments, UE 110 may determine that there is no delivery for the multicast service for UEs in an inactive state in cell 122a of second wireless network node 120 and transmit, after said determination, a request for the reconnection with cell 120a of first wireless network node 120. For instance, UE 110 may transmit the request in an RRC resume request message.

In some example embodiments, UE 110 may transmit an indication indicating that the request is for reconnecting for service continuity of the multicast service. Said indication indicating that the request is for reconnecting for service continuity of the multicast service may be transmitted in an RRC resume request, possibly as a cause value, or in an RRC Resume Complete message. If UE 110 transmits said indication indicating that the request is for reconnecting for service continuity of the multicast service in the RRC resume request message, first wireless network node 120 may request for early measurements to be provided within the RRC resume complete message. In such a case, first wireless network node 120 may decide on handover to cell 122a as soon as possible, which would avoid unnecessary delays before handover from cell 120a.

In some example embodiments, first wireless network node 120 may transmit to UE 110 a threshold value, like a delta, to be used for handover decisions, like cell reselection. For instance, first wireless network node 120 may transmit the threshold value on the MCCH. First wireless network node 120 may transmit the threshold value to be used for handover decisions in cell 120a when the UEs are in the connected state, possibly per cell per service. UE 110 may then transmit the request for reconnection when measurement results of cell 120a of first wireless network node 120 are less than measurement results of cell 122a of second wireless network node 122 by at least the threshold value or when the measurement results of cell 122a of second wireless network node 122 are larger than the at least one threshold (i.e., without considering a source cell, like cell 120a of first wireless network node 120), but not before. UE 110 would hence only perform reconnection for service continuity if the measurements in a target cell are above the measurements of the currently camped cell, i.e., the serving cell. By transmitting the threshold value via the MCCH, first wireless network node 120 may thus avoid too early requests for reconnection by UE 110. The threshold value may be related to for example Reference Signal Received Power, RSRP, Reference Signal Received Quality, RSRQ, Bit Error Ratio, BER, Block Error Ratio, BLER, etc.

Alternatively, or in addition, first wireless network node 120 may transmit to UE 110 at least one criterion to be used for cell reselection. The at least one criterion may be for example that RSRP, RSRQ, BER or BLER is to be measured by UE 110 and considered for the cell reselection. If both, the threshold value and the at least one criterion, are transmitted, the at least one criterion may be related to the threshold value.

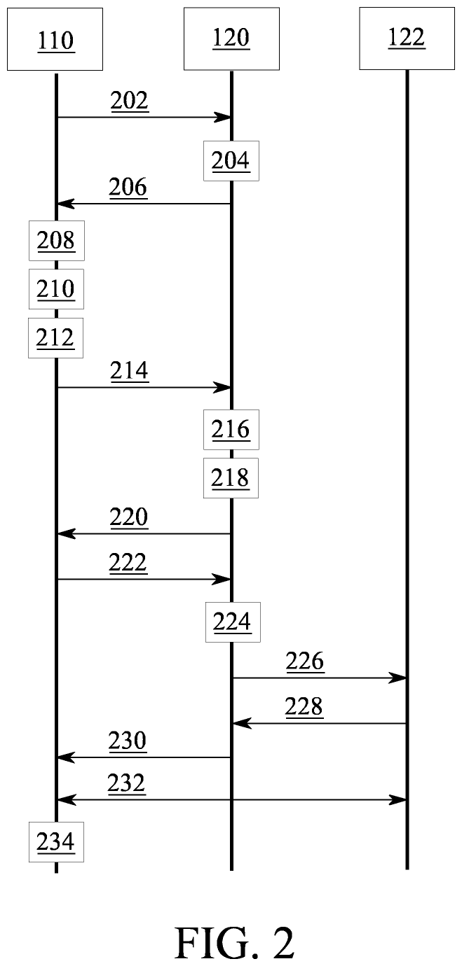

FIG. 2 illustrates a signalling graph in accordance with at least some example embodiments. On the vertical axes are disposed, from the left to the right, UE 110, first wireless network node 120 and second wireless network node 122. Time advances from the top towards the bottom.

At step 202, first wireless network node 120 may activate multicast transmission of a multicast service, like Session A, for UEs in the inactive state, like the RRC_INACTIVE state. First wireless network node 120 may transmit an activation indication to UE 110, to activate UE 110 for reception of the multicast service in cell 120a. After wireless network node 120 has activated a mode of reception in the inactive state in cell 120a for the multicast service, UE 110 may start receiving the multicast service, i.e., multicast transmissions, in the inactive state. In addition, UE 110 may start monitoring the MCCH for possible modifications related to the multicast service.

At step 204, first wireless network node 120 may decide to enable reconnection to cell 120a for service continuity, for example if congestion is not severe in cell 120a of first wireless network node 120. Hence, first wireless network node 120 may decide to enable the reconnection for service continuity of the ongoing multicast service with UE 110, while UE 110 is in the inactive state.

At step 206, first wireless network node 120 may transmit information indicating that the reconnection to cell 120a is enabled for continuing the multicast service. For instance, first wireless network node 120 may broadcast that reconnection for service continuity is allowed in cell 120a. Said information indicating that the reconnection to cell 120a is enabled for continuing the multicast service may be for example a flag. In some example embodiments, first wireless network node 120 may transmit, at step 206, periodic MCCH transmissions.

In some example embodiments, first wireless network node 120 may also transmit, at step 206, the threshold value and/or the at least one criterion to UE 110, to be used for handover decisions, like cell reselection and continuity decisions. In some example embodiments, the threshold value is associated with both, cell 120a and cell 122a. Alternatively, the threshold value may be associated with cell 122a, i.e., applied without considering cell 120a, or vice-versa.

The threshold value and/or the at least one criterion may be broadcasted by first wireless network node 120. UE 110 may thus receive, from first wireless network node 120, the threshold to be used for cell reselection decisions. Alternatively, or in addition, UE 110 may receive, from first wireless network node 120, the at least one criterion to be used for cell reselection decisions. The threshold value and/or the at least one criterion may be used by UEs in their cell reselection and reconnection decision in cell 120a. Such threshold and/or criterion can be different for each neighbor cell of Cell 120a and for each multicast service.

At step 208, UE 110 may be in the inactive state in cell 120a of first wireless network node 120. UE 110 may also receive the multicast service, like multicast session A. Hence, UE 110 may have an ongoing multicast service with cell 120a of first wireless network node 120a while it is in the inactive state.

At step 210, UE 110 may determine that there is no delivery for the multicast service for UEs in the inactive state in cell 122a of second wireless network node 122. UE 110 may for example learn that there is no multicast delivery for the multicast service to UEs in the inactive state in cell 122a of second wireless network node 120 from the MCCH of cell 120a. Alternatively, UE 110 may learn that by reading a SIB, like SIB20 on the MCCH of cell 120b. In some example embodiments, cell 122a of second wireless network node 122 may be referred to as a target cell selected by UE 110 for camping. Hence, UE 110 may receive the multicast service in the inactive state in cell 120a and learn that cell 122a does not deliver the multicast service for UEs in the inactive state in cell 122a.

At step 212, UE 110 may decide to reconnect to cell 120a before reselecting cell 122a for camping. That is, UE 110 may decide to reconnect to cell 120a before a reselecting cell 122a for camping, instead of performing a reselection to cell 122a directly without reconnecting to cell 120a. For instance, UE 110 may decide to reconnect to cell 120a before reselecting cell 122a for camping when measurement results of cell 120a of first wireless network node 120 are less than measurement results of cell 122a of second wireless network node 122 by at least the threshold value. That is, UE may decide to reconnect to cell 120a before reselecting cell 122a for camping only if measurements of cell 120a+delta<measurements of cell 122a. Alternatively, or in addition, the decision to reconnect to cell 120a before reselecting cell 122a for camping may be based on the performed measurements and the at least one criterion, if the at least one criterion has been received from first wireless network node 120 by UE 110.

At step 214, UE 110 may transmit a request for the reconnection to cell 120a of first wireless network node 120. The request may be for example a RRC Resume Request. UE 110 may transmit the request for the reconnection to cell 120a when measurement results of cell 120a of first wireless network node 120 are less than measurement results of cell 122a of second wireless network node 122 by at least the threshold value or when the measurement results of cell 122a of second wireless network node 122 are larger than the at least one threshold. Alternatively, or in addition, UE 110 may transmit the request for the reconnection to cell 120a of first wireless network node 120 when at least one of the at least one criterion is met. In some example embodiments, the request for the reconnection may comprise a cause value indicating reconnection for service continuity.

In some example embodiments, UE 110 may transmit to first wireless network node 120 an indication indicating that the request is for reconnecting for service continuity of the multicast service, e.g., for session A. Alternatively, or in addition, UE 110 may transmit to first wireless network node 120 an indication indicating that first wireless network node 120 is to request for measurements. That is, UE 110 may transmit an indication indicating an expectation to receive a measurement request from first wireless network node 120, e.g., in a RRC resume request. For instance, UE 110 may include in the RRC resume request a cause value, like “MBS continuity”, or a more generic “measurement indication” to indicate to first wireless network node 120 that it should ask for measurements.

At step 216, first wireless network node 120 may understand that the reason for requesting for the reconnection is service continuity. At step 218, first wireless network node 120 may understand that it should request for measurements. First wireless network node 120 may hence determine, based on the request for the reconnection with cell 120 of first wireless network node 120a, to request measurements from UE 110 and transmit, to UE 110, a request for said measurements.

At step 220, first wireless network node 120 may transmit a RRC resume message and a request for measurements to UE 110. First wireless network node 120 may hence acknowledge in the RRC resume message the request received at step 214 and ask UE 110 to perform measurements for a handover. UE 110 may perform said measurements after receiving the RRC resume message.

At step 222, UE 110 may transmit a RRC resume complete message along with results of said measurements to first wireless network node 120. In some example embodiments, UE 110 may for example transmit, responsive to receiving the RRC resume message, at least one of an identity of an intended cell for camping, like cell 122a, measurement results or a cause value indicating reconnection for service continuity.

At step 224, first wireless network node 120 may decide to handover UE 110 to cell 120a. That is, first wireless network node 120 may decide, based on the RRC resume message received from UE 110, to handover UE 110 to cell 122a of second wireless network node 120. For instance, first wireless network node 120 may decide to handover UE 110 based on at least one of an identity of an intended cell for camping, like cell 122a, received measurement results or the cause value indicating reconnection for service continuity.

At step 226, first wireless network node 120 may transmit a handover request to second wireless network node 122. That is, first wireless network node 120 may, after deciding to handover UE 110, transmit the handover request to second wireless network node 122. First wireless network node 120 may thus transmit the handover request based on the request of UE 110 for the reconnection to cell 120a of first wireless network node 120. Transmission of the handover request may also be based on the indication indicating that the request is for reconnecting for service continuity of the multicast service, e.g., when the indication is received in an RRC resume complete message rather than in a RRC resume request message. In some example embodiments, first wireless network 120 may decide to handover UE 110 to another wireless network node though, and in such a case transmit the handover request to said another wireless network node.

At step 228, second wireless network node 122 may transmit a handover request acknowledgement to first wireless network node 120. At step 230, first wireless network node 120 may transmit a handover command to UE 110. At step 232, UE 110 may perform random access to cell 122a. At step 234, UE 110 may receive data, i.e., the multicast service, in the connected state from cell 122a.

In some example embodiments, the handover may be an intra-BS handover, e.g., between cells of first wireless network node 120. In such a case, first wireless network node 120 and second wireless network node 122 may refer to the same wireless network node, like first wireless network node 120. Hence, in some example embodiments, cell 122a of second wireless network node 122 may refer to another cell of first wireless network node 120.

Embodiments of the present disclosure therefore make it possible for a wireless network node, like first wireless network node 120, to control reconnections in a serving cell, like in cell 120a serving UE 110, by taking into account the service continuity intention of UE 110. Decisions of cell selection at the UE and handover at the wireless network node may be aligned. Furthermore, in some example embodiments, the wireless network node may receive results of the measurement performed by the UE as early as possible to trigger handover decisions while still being able to provide service continuity for multicast services. Multicast services may be hence delivered in an improved manner.

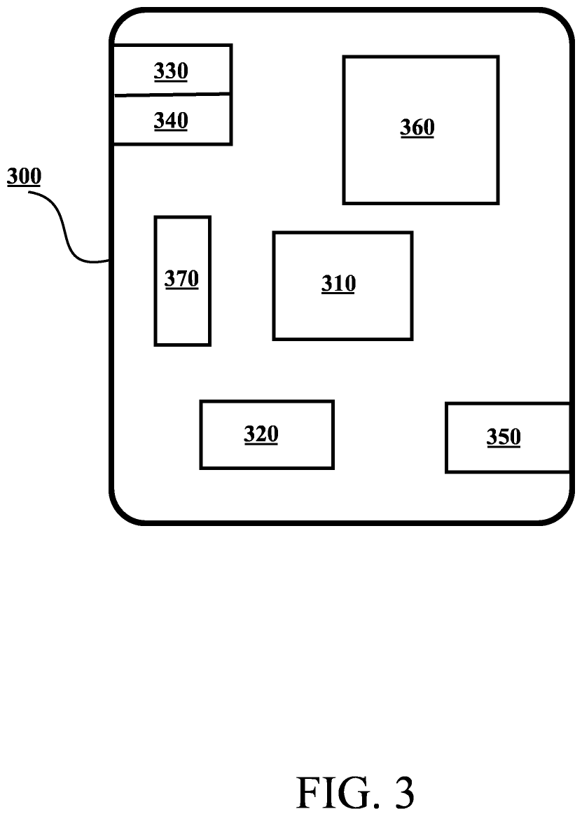

FIG. 3 illustrates an example apparatus capable of supporting at least some example embodiments. Illustrated is device 300, which may comprise, for example, UE 110 or first wireless network node 120, or a device controlling functioning thereof, possibly when installed therein. Comprised in device 300 is processor 310, which may comprise, for example, a single- or multi-core processor wherein a single-core processor comprises one processing core and a multi-core processor comprises more than one processing core. Processor 310 may comprise, in general, a control device. Processor 310 may comprise more than one processor. Processor 310 may be a control device. Processor 310 may comprise at least one Application-Specific Integrated Circuit, ASIC. Processor 310 may comprise at least one Field-Programmable Gate Array, FPGA. Processor 310 may comprise at least one Qualcomm Snapdragon and/or Intel Atom processor. Processor 310 may comprise, for example, a Cortex-A8 processing core manufactured by ARM Holdings or a Steamroller processing core produced by Advanced Micro Devices Corporation. Processor 310 may be means for performing method steps in device 300, such as determining, causing transmitting and causing receiving. Processor 310 may be configured, at least in part by computer instructions, to perform actions.

A processor may comprise circuitry, or be constituted as circuitry or circuitries, the circuitry or circuitries being configured to perform phases of methods in accordance with example embodiments described herein. As used in this application, the term “circuitry” may refer to one or more or all of the following: (a) hardware-only circuit implementations, such as implementations in only analog and/or digital circuitry, and (b) combinations of hardware circuits and software, such as, as applicable: (i) a combination of analog and/or digital hardware circuit(s) with software/firmware and (ii) any portions of hardware processor(s) with software (including digital signal processor(s)), software, and memory(ies) that work together to cause an apparatus, such as a network function, to perform various functions) and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Device 300 may comprise memory 320. Memory 320 may comprise random-access memory and/or permanent memory. Memory 320 may comprise at least one RAM chip. Memory 320 may comprise solid-state, magnetic, optical and/or holographic memory, for example. Memory 320 may be at least in part accessible to processor 310. Memory 320 may be at least in part comprised in processor 310. Memory 320 may be means for storing information. Memory 320 may comprise computer instructions that processor 310 is configured to execute. When computer instructions configured to cause processor 310 to perform certain actions are stored in memory 320, and device 300 overall is configured to run under the direction of processor 310 using computer instructions from memory 320, processor 310 and/or its at least one processing core may be considered to be configured to perform said certain actions. Memory 320 may be at least in part comprised in processor 310. Memory 320 may be at least in part external to device 300 but accessible to device 300.

Device 300 may comprise a transmitter 330. Device 300 may comprise a receiver 340. Transmitter 330 and receiver 340 may be configured to transmit and receive, respectively, information in accordance with at least one cellular or non-cellular standard. Transmitter 330 may comprise more than one transmitter. Receiver 340 may comprise more than one receiver. Transmitter 330 and/or receiver 340 may be configured to operate in accordance with Global System for Mobile communication, GSM, Wideband Code Division Multiple Access, WCDMA, Long Term Evolution, LTE, and/or 5G/NR standards, for example.

Device 300 may comprise a Near-Field Communication, NFC, transceiver 350. NFC transceiver 350 may support at least one NFC technology, such as Bluetooth, Wibree or similar technologies.

Device 300 may comprise User Interface, UI, 360. UI 360 may comprise at least one of a display, a keyboard, a touchscreen, a vibrator arranged to signal to a user by causing device 300 to vibrate, a speaker and a microphone. A user may be able to operate device 300 via UI 360, for example to accept incoming telephone calls, to originate telephone calls or video calls, to browse the Internet, to manage digital files stored in memory 320 or on a cloud accessible via transmitter 330 and receiver 340, or via NFC transceiver 350, and/or to play games.

Device 300 may comprise or be arranged to accept a user identity module 370. User identity module 370 may comprise, for example, a Subscriber Identity Module, SIM, card installable in device 300. A user identity module 370 may comprise information identifying a subscription of a user of device 300. A user identity module 370 may comprise cryptographic information usable to verify the identity of a user of device 300 and/or to facilitate encryption of communicated information and billing of the user of device 300 for communication effected via device 300.

Processor 310 may be furnished with a transmitter arranged to output information from processor 310, via electrical leads internal to device 300, to other devices comprised in device 300. Such a transmitter may comprise a serial bus transmitter arranged to, for example, output information via at least one electrical lead to memory 320 for storage therein. Alternatively to a serial bus, the transmitter may comprise a parallel bus transmitter. Likewise processor 310 may comprise a receiver arranged to receive information in processor 310, via electrical leads internal to device 300, from other devices comprised in device 300. Such a receiver may comprise a serial bus receiver arranged to, for example, receive information via at least one electrical lead from receiver 340 for processing in processor 310. Alternatively to a serial bus, the receiver may comprise a parallel bus receiver.

Device 300 may comprise further devices not illustrated in FIG. 3. For example, where device 300 comprises a smartphone, it may comprise at least one digital camera. Some devices 300 may comprise a back-facing camera and a front-facing camera, wherein the back-facing camera may be intended for digital photography and the front-facing camera for video telephony. Device 300 may comprise a fingerprint sensor arranged to authenticate, at least in part, a user of device 300. In some embodiments, device 300 lacks at least one device described above. For example, some devices 300 may lack a NFC transceiver 350 and/or user identity module 370.

Processor 310, memory 320, transmitter 330, receiver 340, NFC transceiver 350, UI 360 and/or user identity module 370 may be interconnected by electrical leads internal to device 300 in a multitude of different ways. For example, each of the aforementioned devices may be separately connected to a master bus internal to device 300, to allow for the devices to exchange information. However, as the skilled person will appreciate, this is only one example and depending on the embodiment various ways of interconnecting at least two of the aforementioned devices may be selected without departing from the scope of the embodiments.

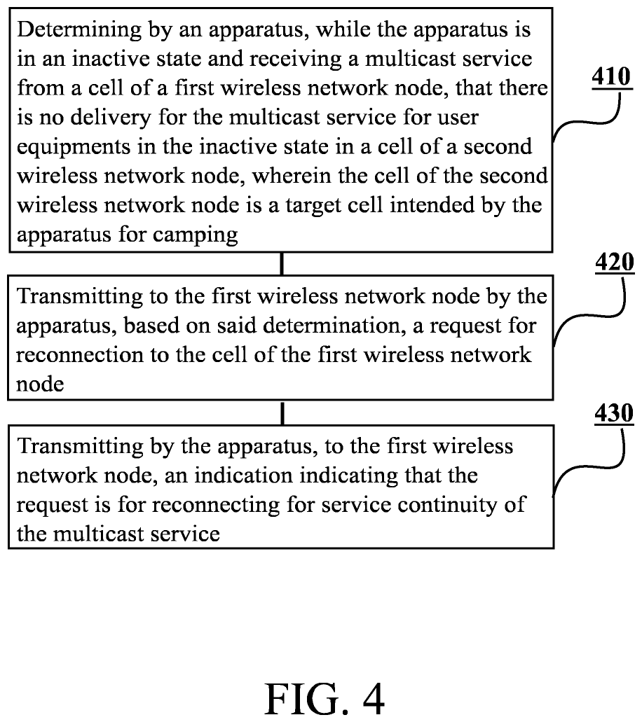

FIG. 4 is a flow graph of a first method in accordance with at least some example embodiments. The phases of the illustrated first method may be performed by UE 110, or a device controlling functioning thereof, possibly when installed therein.

The first method may comprise, at step 410, determining by an apparatus, while the apparatus is in an inactive state and receiving a multicast service from a cell of a first wireless network node, that there is no delivery for the multicast service for user equipments in the inactive state in a cell of a second wireless network node, wherein the cell of the second wireless network node is a target cell intended by the apparatus for camping. The first method may also comprise, at step 420, transmitting to the first wireless network node by the apparatus, based on said determination, a request for reconnection to the cell of the first wireless network node. Finally, the first method may comprise, at step 430, transmitting by the apparatus, to the first wireless network node, an indication indicating that the request is for reconnecting for service continuity of the multicast service.

It is to be understood that the example embodiments disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular example embodiments only and is not intended to be limiting.

Reference throughout this specification to one example embodiment or an example embodiment means that a particular feature, structure, or characteristic described in connection with the example embodiment is included in at least one example embodiment. Thus, appearances of the phrases “in one example embodiment” or “in an example embodiment” in various places throughout this specification are not necessarily all referring to the same example embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various example embodiments and examples may be referred to herein along with alternatives for the various components thereof. It is understood that such example embodiments, examples, and alternatives are not to be construed as de facto equivalents of one another, but are to be considered as separate and autonomous representations.

In an example embodiment, an apparatus, comprising for example UE 110 or first wireless network node 120, may further comprise means for carrying out the example embodiments described above and any combination thereof. The apparatus may be an apparatus of a cellular communication network, such as a 5G network, and comprise means for operating in the cellular communication network.

In an example embodiment, a computer program comprising instructions which, when the program is executed by a computer, cause the computer to carry out a method in accordance with the example embodiments described above and any combination thereof. In an example embodiment, a computer program product, embodied on a non-transitory computer readable medium, may be configured to control a processor to perform a process comprising the example embodiments described above and any combination thereof.

In an example embodiment, an apparatus, comprising for example UE 110 or first wireless network node 120, may further comprise at least one processor, and at least one memory including computer program code, wherein the at least one memory and the computer program code are configured to, with the at least one processor, cause the apparatus at least to perform the example embodiments described above and any combination thereof. The apparatus may be an apparatus of a cellular communication network, such as a 5G network, and configured to operate in the cellular communication network.

Furthermore, the described features, structures, or characteristics may be combined in any suitable manner in one or more example embodiments. In the preceding description, numerous specific details are provided, such as examples of lengths, widths, shapes, etc., to provide a thorough understanding of example embodiments of the invention. One skilled in the relevant art will recognize, however, that the invention may be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the example embodiments in one or more particular applications, it will be apparent to those of ordinary skill in the art that numerous modifications in form, usage and details of implementation may be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

The expression “at least one of A or B” in this document means A, or B, or both A and B.

### INDUSTRIAL APPLICABILITY

At least some example embodiments find industrial application in cellular communication networks wherein multicast services are provided, such as in 5G networks, and possibly in other cellular communication networks in the future as well.

ACRONYMS LIST

| | |
|---|---|
| 3GPP | 3rd Generation Partnership Project |
| BER | Bit Error Ratio |
| BLER | Block Error Ratio |
| BS | Base Station |
| D2D | Device-to-Device |
| G-RNTI | GERAN Radio Network Temporary Identifier |
| GSM | Global System for Mobile communication |
| IoT | Internet of Things |
| LTE | Long-Term Evolution |
| M2M | Machine-to-Machine |
| MTC | Machine Type Communications |
| MBS | Multicast and Broadcast Services |
| MCCH | Multicast Control Channel |
| NFC | Near-Field Communication |
| NR | New Radio |
| QoS | Quality of Service |
| RAT | Radio Access Technology |
| RedCap | Reduced Capability |
| RNA | RAN-based Notification Area |
| RRC | Radio Resource Control |
| RSRP | Reference Signal Received Power |
| RSRQ | Reference Signal Received Quality |
| SIB | System Information Block |
| TRP | Transmission and Reception Point |
| UE | User Equipment |
| UI | User Interface |
| WCDMA | Wideband Code Division Multiple Access |
| WiMAX | Worldwide Interoperability for Microwave Access |
| WLAN | Wireless Local Area Network |

REFERENCE SIGNS LIST

| | |
|---|---|
| 110 | UE |
| 115 | Air interface |
| 120 | First wireless network node |
| 120a | Cell of first wireless network node 120 |
| 122 | Second wireless network node |
| 122a | Cell of second wireless network node 122 |
| 125, 135 | Wired interfaces |
| 130 | Core network |
| 202-234 | Steps in the signalling graph of FIG. 2 |
| 300-370 | Structure of the apparatus of FIG. 3 |
| 410-430 | Phases of the method in FIG. 4 |

1. An apparatus, comprising:
at least one processor; and
at least one memory storing instructions that, when executed by the at least one processor, cause the apparatus at least to:
determine, while the apparatus is in an inactive state and receiving a multicast service from a cell of a first wireless network node, that there is no delivery for the multicast service for user equipments in the inactive state in a cell of a second wireless network node, wherein the cell of the second wireless network node is a target cell intended by the apparatus for camping;
transmit to the first wireless network node, based on said determination, a request for reconnection to the cell of the first wireless network node; and
transmit, to the first wireless network node, an indication indicating that the request is for reconnecting for service continuity of the multicast service.

2. The apparatus according to claim 1, wherein the at least one memory further stores instructions that, when executed by the at least one processor, cause the apparatus at least to:
receive, from the first wireless network node, a threshold value; and
transmit, to the first wireless network node, the request for the reconnection to the cell of the first wireless network node when measurement results of the cell of the first wireless network node are less than measurement results of the cell of the second wireless network node by at least the threshold value or when the measurement results of the cell of the second wireless network node are larger than the at least one threshold or when the measurement results of the cell of the first wireless network node are smaller than the at least one threshold.

3. The apparatus according to claim 1, wherein the at least one memory further stores instructions that, when executed by the at least one processor, cause the apparatus at least to:
receive, from the first wireless network node, at least one criterion; and
transmit, to the first wireless network node, the request for the reconnection with the cell of the first wireless network node when at least one of the at least one criterion is met.

4. The apparatus according to claim 1, wherein the at least one memory further stores instructions that, when executed by the at least one processor, cause the apparatus at least to:
receive, from the first wireless network node, information indicating that a reconnection to a cell of the first wireless network node is enabled for service continuity of the multicast service.

5. The apparatus according to claim 1, wherein said indication indicating that the request is for service continuity of the multicast service is transmitted in a radio resource control resume request message or in a radio resource control resume complete message.

6. The apparatus according to claim 1, wherein the at least one memory further stores instructions that, when executed by the at least one processor, cause the apparatus at least to:
transmit, to the first wireless network node, an indication indicating an expectation to receive a measurement request from the first wireless network node.

7. The apparatus according to claim 6, wherein said indication indicating said expectation to receive the measurement request from the first wireless network node is transmitted in a radio resource control resume request message.

8. The apparatus according to claim 1, wherein the at least one memory further stores instructions that, when executed by the at least one processor, cause the apparatus at least to:
receive, from the first wireless network node, a radio resource control resume message; and
transmit to the first wireless network node, responsive to receiving the radio resource control resume message, in a radio resource control resume complete message at least one of an identity of the cell of the second wireless network node, measurement results or a cause value indicating reconnecting for service continuity of the multicast service.

9. The apparatus according to claim 1, wherein said information indicating that the reconnection to the cell of the first wireless network node is enabled for service continuity of the multicast service is received on a multicast control channel.

10. The apparatus according to claim 1, wherein the apparatus is a user equipment or a control device configured to control the user equipment.

11. An apparatus, comprising:
at least one processor; and
at least one memory storing instructions that, when executed by the at least one processor, cause the apparatus at least to:
receive, from a user equipment, a request for reconnection to a cell of the apparatus,
receive, from the user equipment, an indication indicating that the request is for reconnecting for service continuity of a multicast service; and
transmit, based on the request and the indication, a request for measurements to the user equipment or a handover request to a second wireless network node.

12. The apparatus according to claim 11, wherein the at least one memory further stores instructions that, when executed by the at least one processor, cause the apparatus at least to:
transmit, to the user equipment, a threshold value; and
receive, from the user equipment, the request for the reconnection to the cell of the apparatus when measurement results of the cell of the apparatus are less than measurement results of a cell of a second wireless network node by at least the threshold value or when the measurement results of the cell of the second wireless network node are larger than the at least one threshold.

13. The apparatus according to claim 11, wherein the at least one memory further stores instructions that, when executed by the at least one processor, cause the apparatus at least to:
transmit, to the user equipment, at least one criterion;
receive, from the user equipment, the request for the reconnection to the cell of the apparatus when at least one of the at least one criterion is met.

14. The apparatus according to claim 11, wherein the at least one memory further stores instructions that, when executed by the at least one processor, cause the apparatus at least to:
decide to enable the reconnection to the cell of the apparatus for service continuity of the multicast service with the user equipment in the inactive state; and
transmit, to the user equipment, information indicating that the reconnection to the cell of the apparatus is enabled for service continuity of the multicast service.

15. The apparatus according to claim 11, wherein said indication indicating that the request is for reconnecting for service continuity of the multicast service is received in a radio resource control resume request message or in a radio resource control resume complete message.

16. The apparatus according to claim 11, wherein the at least one memory further stores instructions that, when executed by the at least one processor, cause the apparatus at least to:
receive, from the user equipment, an indication indicating an expectation to receive a measurement request from the apparatus is to request measurements; and
transmit, to the user equipment, a request for said measurements.

17. The apparatus according to claim 16, wherein said indication indicating said expectation to receive the measurement request from the first wireless network node is received in a radio resource control resume request message.

18. The apparatus according to claim 11, wherein the at least one memory further stores instructions that, when executed by the at least one processor, cause the apparatus at least to:
transmit, to the user equipment, a radio resource control resume message; and
receive from the user equipment, responsive to transmitting the radio resource control resume message, in a radio resource control resume complete message at least one of an identity of a cell of a second wireless network node, measurement results or a cause value indicating reconnection for service continuity.

19. The apparatus according to claim 11, wherein said information indicating that the reconnection to the cell of the first wireless network node is enabled for service continuity of the multicast service is transmitted on a multicast control channel.

20. A method, comprising:
determining by a user equipment, while the user equipment is in an inactive state and receiving a multicast service from a cell of a first wireless network node, that there is no delivery for the multicast service for user equipments in the inactive state in a cell of a second wireless network node, wherein the cell of the second wireless network node is a target cell intended by the user equipment for camping;
transmitting, to the first wireless network node and based on said determination, a request for reconnection to the cell of the first wireless network node; and
transmitting, to the first wireless network node, an indication indicating that the request is for reconnecting for service continuity of the multicast service.
